(19) United States
(12) Patent Application Publication
(10) Pub. No.: US 2015/0187226 A1
(43) Pub. Date: Jul. 2, 2015

(54) COMPUTERIZED HEALTH COACHING PLATFORM

(71) Applicant: HUMANA INC., (US)

(72) Inventor: Sean Slovenski, Louisville, KY (US)

(73) Assignee: HUMANA INC., Louisville, KY (US)

(21) Appl. No.: 13/736,018

(22) Filed: Jan. 7, 2013

Related U.S. Application Data
(60) Provisional application No. 61/583,320, filed on Jan. 5, 2012.

(51) Int. Cl. G09B 19/00

(52) U.S. Cl. CPC G09B 19/00

(57) ABSTRACT

An automated system and method for use by health coaches to provide health coaching services to members of a health benefits plan. The platform supports the entry of member data, completion and analysis of assessments, and the development of a health or wellness plan or program for each member. Coaches develop health and wellness plans or programs for members by defining goals and one or more activities for each goal. The platform supports tracking of progress toward goals. Calendaring and task features allow the coach to remain in contact with members. The level of interaction between a coach and a member varies according to the member's needs so the calendaring and task features provide flexibility in scheduling initial and follow-up communications. In addition to defining tasks, coaches may enter progress notes that also assist the coach in determining the level and type of communication to initiate.

### CROSS-REFERENCE TO RELATED APPLICATIONS

This application claims priority to U.S. Application No. 61/583,320 filed on Jan. 5, 2012; which is herein incorporated by reference in its entirety.

### FIELD OF THE INVENTION

The present invention relates to computerized systems and methods for assisting others with the development and maintenance of healthy lifestyle habits. More particularly, the present invention is a computerized system and method for use by health coaches to assist others with the development and maintenance of desirable diet, exercise, and/or other health behaviors and habits through customized communications and advice.

### BACKGROUND OF THE INVENTION

Many people are affected by a variety of health problems including obesity, diabetes, high blood pressure, and elevated cholesterol levels that can be linked to poor habits in diet, exercise, and the like. Although people are generally aware that controlling diet, exercise, and similar lifestyle habits is the best way to become and stay healthy, adopting and maintaining such habits is a difficult task. They may not know where to find diet and exercise information applicable to their personal situation. Even if they are able to find such information, they may not know how to use the information or where to begin when attempting lifestyle changes.

To assist them with adopting and maintaining healthy habits, many people will enlist the help of a personal health advisor or “coach.” Research has shown that individuals are more successful in the difficult endeavor of changing their habits and maintaining new, healthier ones when they are coached throughout the process. Coaching keeps individuals motivated and provides positive reinforcement. Health coaches typically have knowledge of myriad health problems and conditions and can assist individuals with developing plans or programs to improve their health and well-being. The plans and/or programs are developed to meet the specific needs of each individual. As each person's health or condition changes or improves, the individual's coaching needs change accordingly.

Because health coaches typically work with many individuals over long periods of time, they need to collect and maintain a substantial amount of information about each individual so they can provide appropriate advice at every stage. Some individuals may require a substantial amount of assistance when starting a new plan or program or while individuals that have experienced substantial improvement may require less involvement from their coaches. Maintaining an appropriate level of communication with each individual along with appropriate advice contributes to the success of each individualized plan or program. Health coaches may use widely available electronic task management and calendaring systems to assist them with their efforts. Such generalized systems, however, do not address the specific needs of health coaches. They do not provide support for assessments, wellness plan and program development, and related communications. There is a need for a computerized health coach management system and method that supports various coaching activities including development of assessments and wellness programs as well as interactions with individuals and their health benefits providers.

### SUMMARY OF THE INVENTION

The present disclosure describes a platform for use by health coaches to provide health coaching services to members of a health benefits plan. The platform supports the entry of member data, completion and analysis of assessments, and the development of a health or wellness plan or program for each member. Coaches develop health and wellness plans or programs for members by defining health goals and one or more activities for each goal. The platform supports tracking of completion of activities and progress toward goals. Calendaring and task features allow the coach to remain in contact with members. The level of interaction between a coach and a member varies according to the member's needs so the calendaring and task features provide flexibility in scheduling initial and follow-up communications.

The platform further supports communications and interactions between coaches and members to increase the effectiveness of the health or wellness plan or program. The health coach may generate one or more tasks associated with each member. Associated task data may comprise a description of the task as well as the member's current coaching stage. The coaching stage provides information about the member's participation in the coaching program and may assist the coach in determining the level and type of communications to generate. The health coach may also generate one or more progress notes associated with each member. The progress notes may relate the member's health goal or activities related to a health goal.

### BRIEF DESCRIPTION OF THE DRAWINGS

FIG. 1 is a sample member landing page according to an example embodiment;

FIGS. 2A-2B are sample coach interaction pages according to an example embodiment;

FIG. 3 is a block diagram of administrative level implementation details according to an example embodiment;

FIG. 4 is a sample system/workflow process according to an example embodiment;

FIG. 5 has sample site manager page elements for web portal creation according to an example embodiment;

FIG. 6 has sample company manager page elements according to an example embodiment;

FIG. 7 has sample content manager page elements according to an example embodiment;

FIG. 8 has sample link manager page elements according to an example embodiment;

FIG. 9 has sample assessment manager page elements according to an example embodiment;

FIG. 10 has sample report manager page elements according to an example embodiment;

FIG. 11 is a sample coach “virtual office” page according to an example embodiment;

FIG. 12 is a sample “dashboard” page according to an example embodiment;

FIGS. 13A-C are sample appointment dialogue boxes according to an example embodiment;

FIG. 14 is a sample “add new member” dialogue box according to an example embodiment;

FIG. 15 is a sample “calendar” dialogue box according to an example embodiment;

FIGS. 16A-B are sample “appointments” dialogue boxes according to an example embodiment;

FIGS. 17A-B are sample “task” dialogue boxes according to an example embodiment;

FIGS. 18A-C are sample “goals” dialogue boxes according to an example embodiment;

FIGS. 19A-C are sample “activities” dialogue boxes according to an example embodiment;

FIG. 20 is a sample “progress notes” dialogue box according to an example embodiment;

FIGS. 21A-C are sample “private messages” dialogue boxes according to an example embodiment;

FIG. 22A is a sample “complete assessments/surveys” dialogue box according to an example embodiment;

FIG. 22B is a sample “assigned resources” dialogue box according to an example embodiment;

FIG. 22C is a sample “protocols and resources” dialogue box according to an example embodiment;

FIG. 23 is a sample “member information” dialogue box according to an example embodiment;

FIGS. 24A-C are sample member related dialogue boxes according to an example embodiment;

FIGS. 25A-C and FIGS. 26A-26B are sample “unread over 24 hours old” dialogue boxes according to an example embodiment;

FIGS. 27A-27C and FIGS. 28A-28B are sample “unread item” dialogue boxes according to an example embodiment;

FIG. 29 is a sample “overdue tasks” dialogue box according to an example embodiment;

FIG. 30A is a sample “today's tasks” dialogue box according to an example embodiment;

FIGS. 30A-30C are sample “today's appointments” dialogue boxes according to an example embodiment; and

FIGS. 31A-31C are sample dialogue boxes for a “goals due to expire” feature according to an example embodiment.

### DETAILED DESCRIPTION

The present disclosure relates to a computerized health coaching platform. The platform supports numerous health coach activities and interactions. In an example embodiment, clients of the health coach are health benefit provider companies. The individuals that receive coaching services are members of the health benefit provider companies. The platform supports client (health benefit provider) and member interactions and facilitates tracking of member progress toward various health and wellness goals. The platform further supports communications between the coach and member to increase the likelihood of each member reaching his or her personal goals.

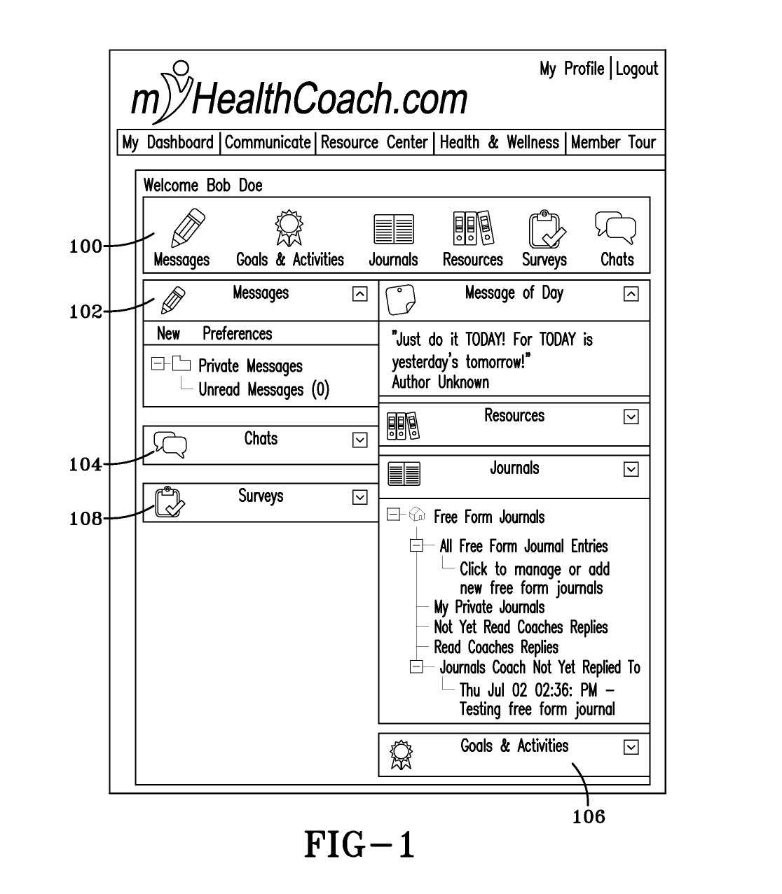

Referring to FIG. 1, a sample member landing page according to an example embodiment is shown. In an example embodiment, a member may customize the landing page using customizable widgets 100. Data used to populate various fields on the page may be obtained from sources that are external to the platform such as a database of member health claim data from a health benefits provider site. Additional functionality includes support of various communication modules, goal forms and personal library tools such as email, journals, goals, resource libraries, and a chat center. Each member of a health benefits provider plan may access a customized health coach portal to receive the services of a health coach that develops a personalized health or wellness plan for the member.

In an example embodiment, the member landing page comprises a “message” section 102 as well as a “chat” section 104 for communicating with a health coach. The page further comprises a “goal and activities” section 106 for accessing details related to personalized goals and activities established for the member in collaboration with the health coach. The member may complete one or more assessments or surveys 108 that provide the health coach with information relevant to the member's health and wellness needs.

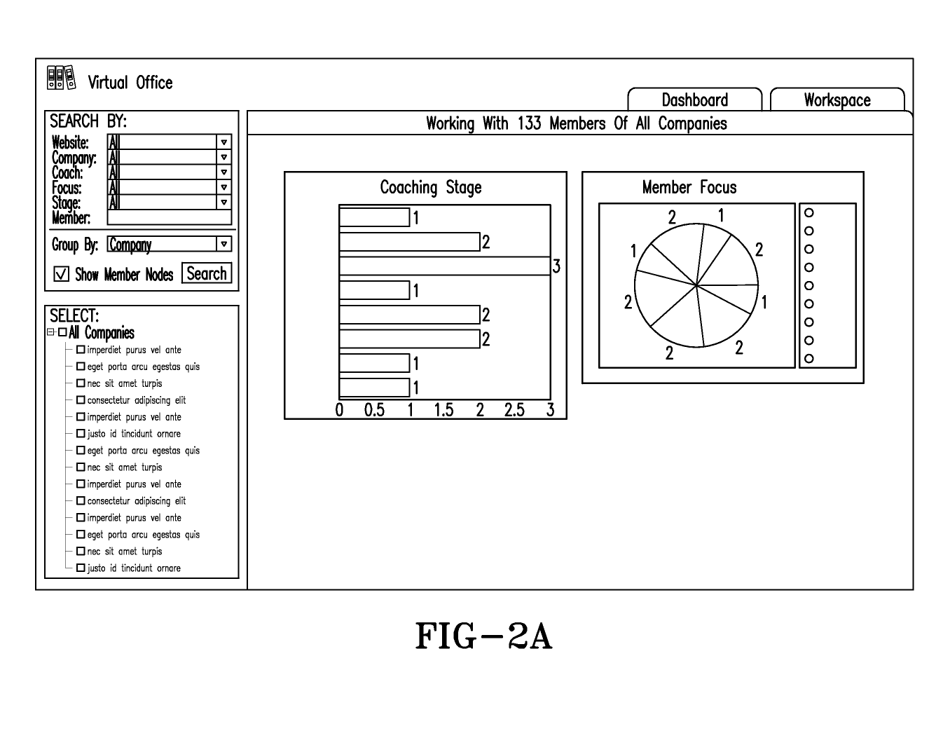

Referring to FIGS. 2A and 2B, sample coach interaction pages according to an example embodiment are shown. In an example embodiment, the platform supports the development of customized portals and provides templates for communications, activities, and goals as well as calendaring features. The platform further facilitates access to data from one or more health benefits providers so that the health coach may access current health related data for each member he or she supports. Communications with the health benefits providers are also supported. The platform also provides reporting and analysis features and customizable workflow features. “Reminder” features support communications with members to enhance member experience and increase the effectiveness of each member's wellness program or plan.

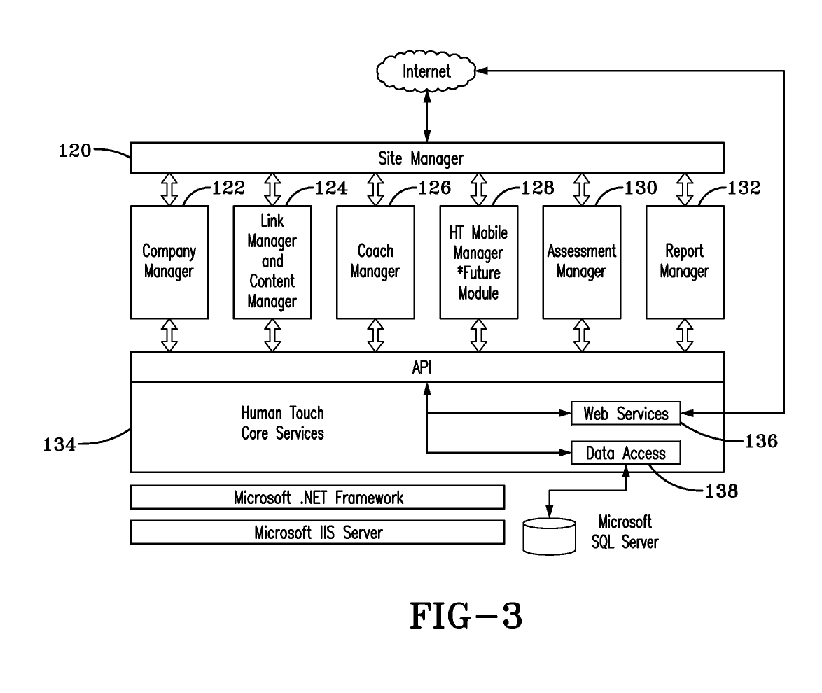

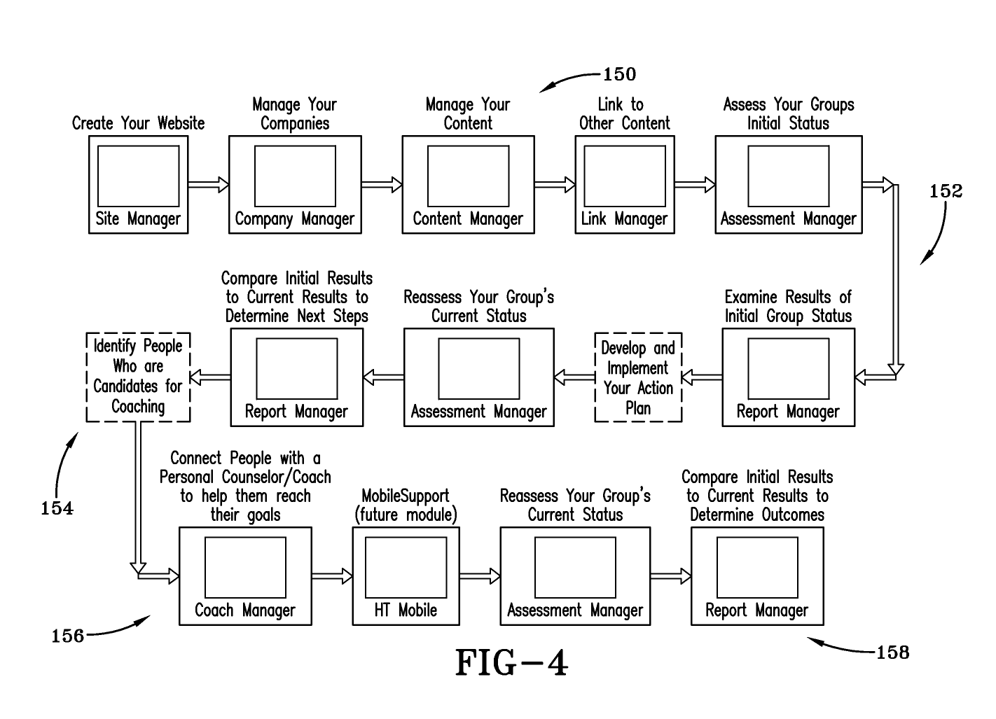

Referring to FIG. 3, a block diagram of administrative level implementation details according to an example embodiment is shown. In an example embodiment, Software as a Service (SaaS) delivery modules include:

TABLE 1
Functional Modules

| Module | Description |
|---|---|
| Site Manager | Web portal creation |
| 120 | |
| Company Manager | Customer management |
| 122 | |
| Link Manager and Content Manager | Content creation and organization |
| 124 | |
| Coach Manager | Member interactions |
| 126 | |
| HT Mobile Manager | Mobile communications manager |
| 128 | |
| Assessment Manager | Create health assessments |
| 130 | |
| Report Manager | Generate reports |
| 132 | |

A core services component 134 comprises a web services component 136 for providing connectivity with other systems and a data access component 138 to facilitate maintenance of data.

Referring to FIG. 4, a sample system/workflow process according to an example embodiment is shown. Platform features and functionality support not only development and implementation of a portal site and member services but also report and analysis features. The platform provides substantial customization features and functionality for developing a portal site, managing communications with health benefits providers that partner with the health coach to provide coaching services to members, and managing content 150. Additional features and functionality are directed to member assessments and analysis to assist the health coach in developing appropriate customized plans for members of the health benefits providers 152. The platform comprises assessment manager and report manger features to assist the coach in completing initial assessments and re-assessments to allow the coach to develop personalized plans. The assessment and report manager features assist the coach in identifying candidates for coaching 154. A coach manager component supports activities related to personalized plan development and tracking 156. Data collected during the plan development and tracking phases allow the coach to complete additional assessments to evaluate plan and coaching effectiveness 158.

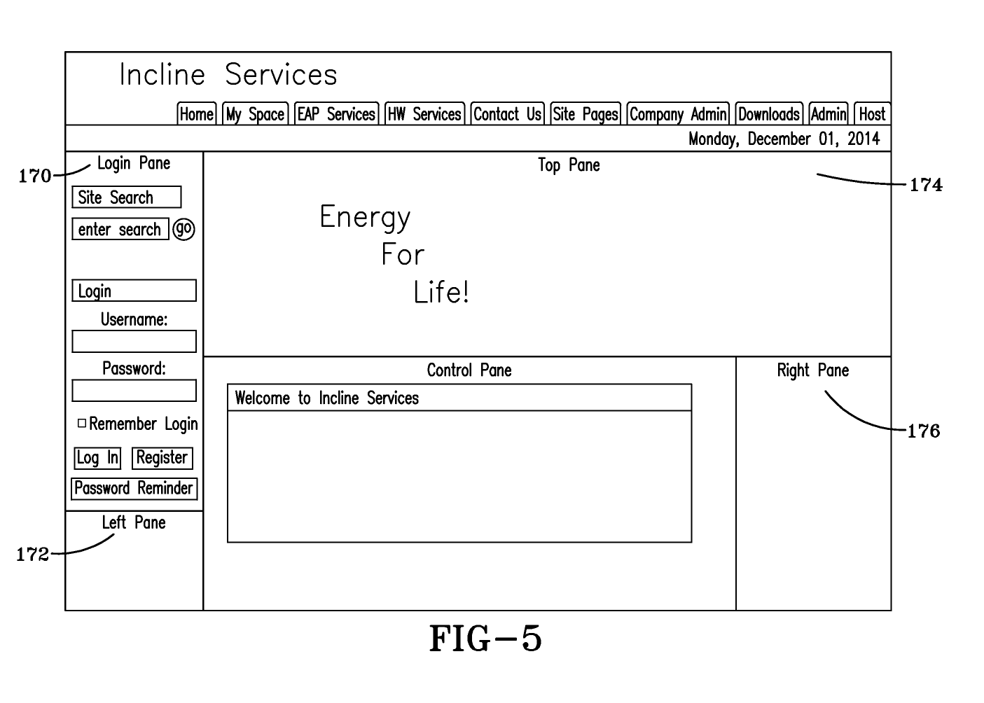

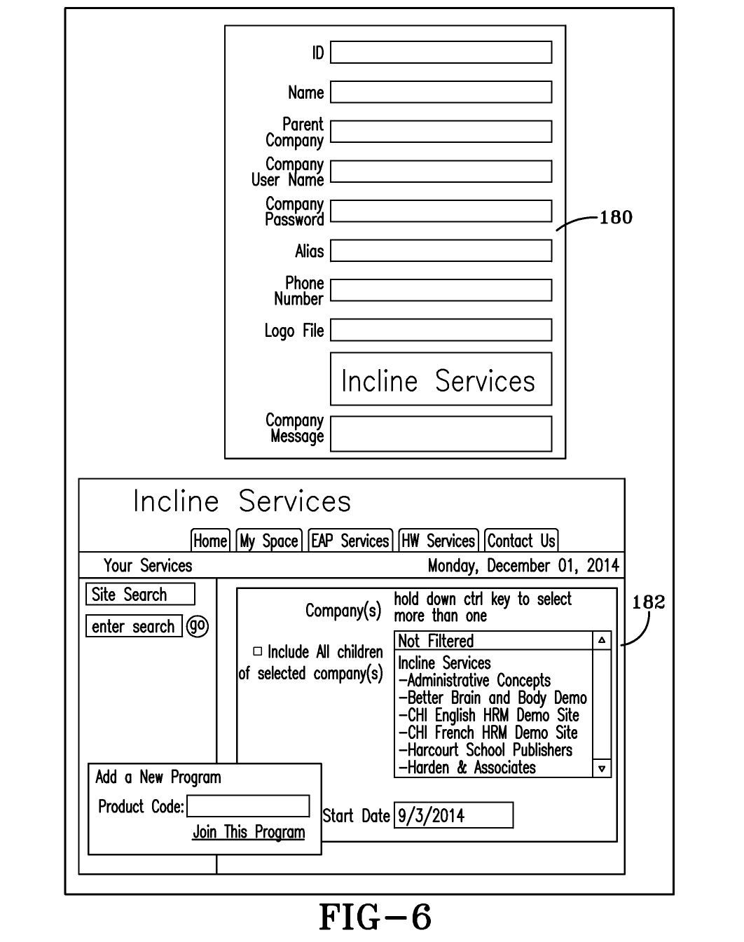

Referring to FIG. 5, sample site manager page elements for web portal creation according to an example embodiment are shown. In an example embodiment, the site manager is implemented as a web-based site builder and content management portal system. It provides numerous modules for features such as HTML page creation, security, forums, site searches, and navigation. In addition, it supports development and deployment of custom modules. Pages comprise a plurality of areas (e.g., login pane 170; left pane 172; top pane 174; and right pane 176), each of which accommodates a module. Page templates may be modified as needed for custom implementations.

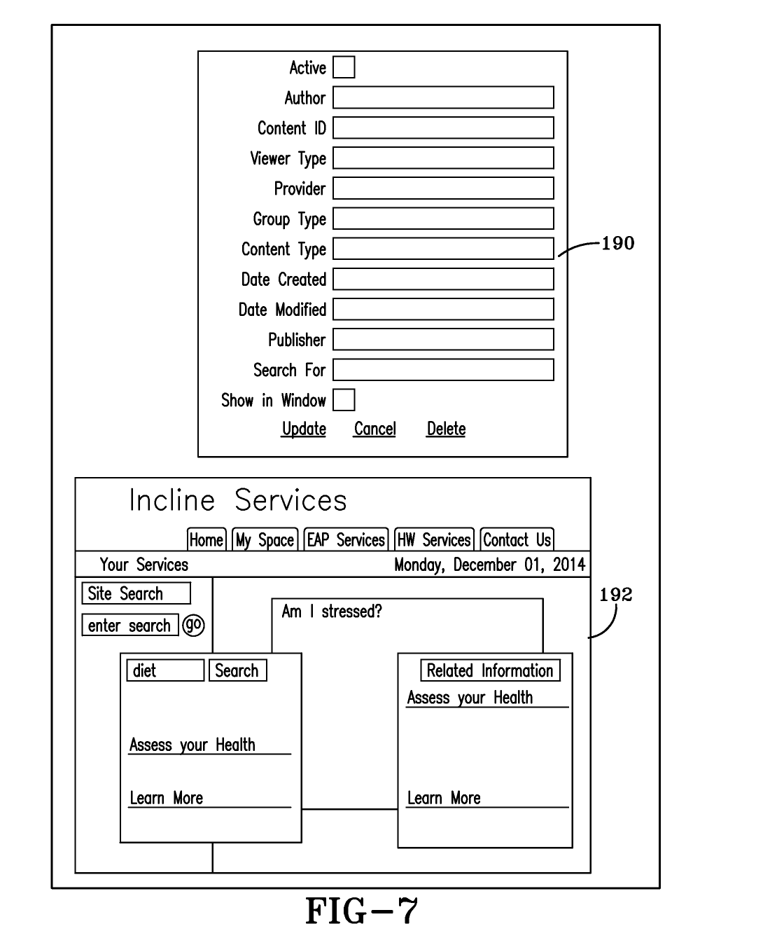

Referring to FIG. 6, sample company manager page elements according to an example embodiment are shown. The company manager module supports management of company details 180 and assignment of companies to sites based on organizational account relationships 182. The company manager module allows a user to customize members' experiences with private labeling and manage subscription-based programs for per-member services. The module is integrated with the site manager and report manager modules to facilitate providing company-specific information.

Referring to FIG. 7, sample content manager page elements according to an example embodiment are shown. The content manager module allows a user to create content units 190 and assign content to groups, categories, authors, and/or publishers 192. The content manager module is integrated with the site manager module that displays and prints content.

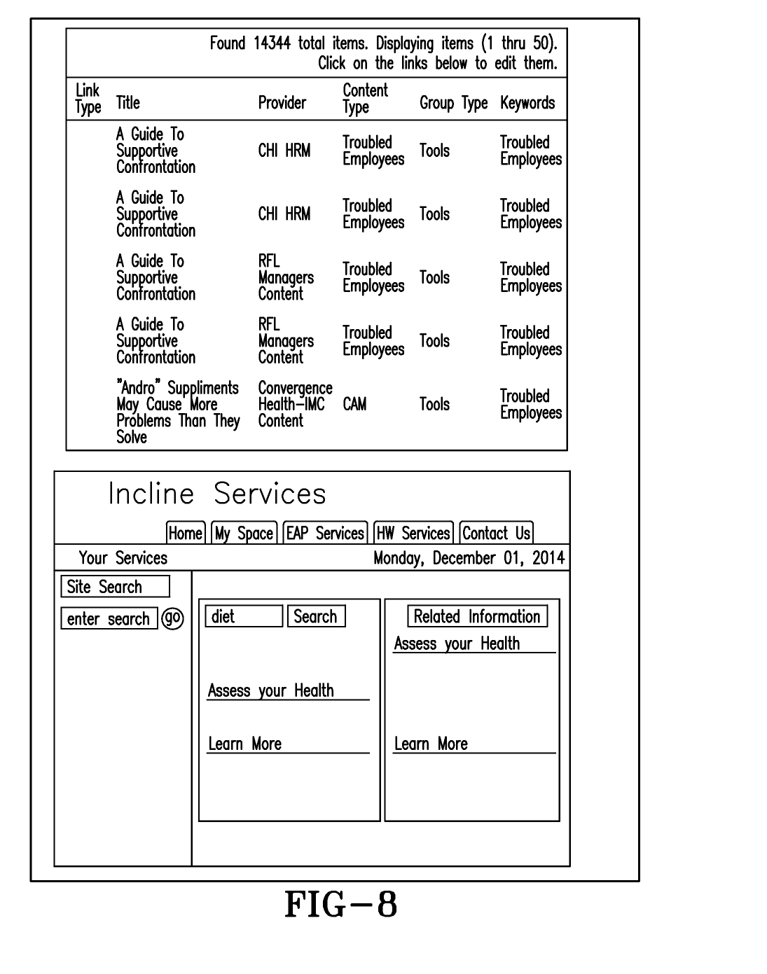

Referring to FIG. 8, sample link manager page elements according to an example embodiment are shown. The link manager module facilitates the location of content to be provided at a portal. A user may access off-site content, website links, URLs or other vendor sites using a remote content connector feature. The site manager provides seamless search ability. A user may assign summaries, keywords, categories, and groupings to content.

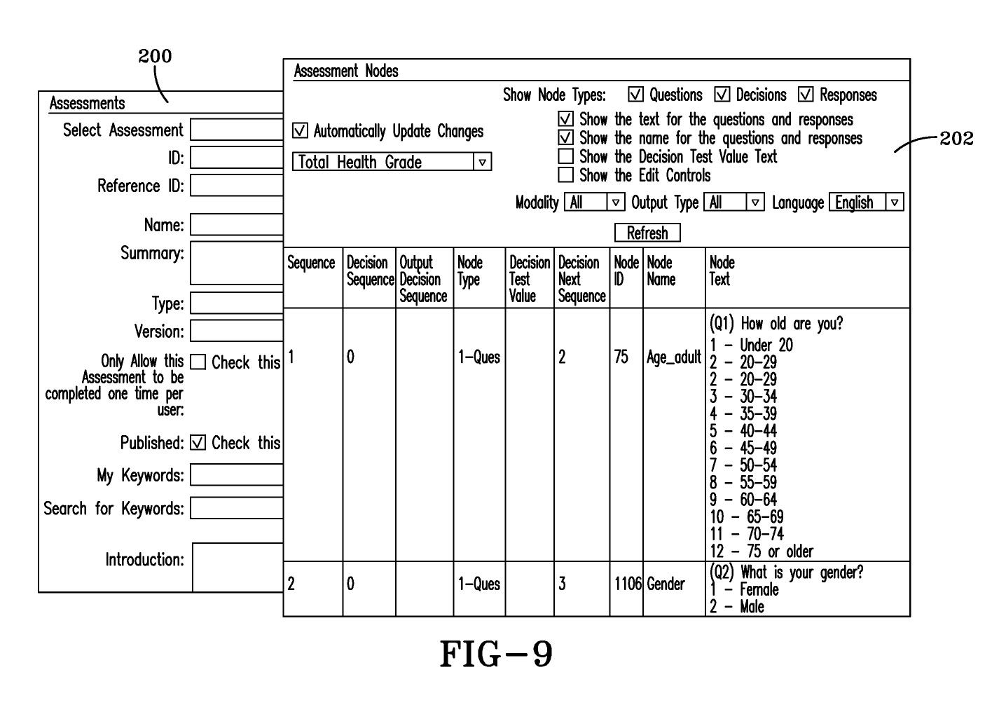

Referring to FIG. 9, sample assessment manager page elements according to an example embodiment are shown. The assessment manager facilitates the creation and testing of assessments 200 and surveys and they way they operate 202. The assessment manager allows a user to create summaries, apply keywords, and record review dates as well as to build a global library of questions and results that can be shared. Different question types are supported (e.g., single choice or multiple choice) as well as “free text” for user-entered information. In an example embodiment, a node list construction design is supported with three types of nodes: question, decision, and result. The design supports branching logic. The assessment manager also maintains historical data of previous answers, results, and completed assessments for use in the report manager. The assessment manager is integrated with the link manager to provide dynamic, related information based on keywords and actual assessment results. The assessment manager features help coaches identify candidates for coaching based on member assessments.

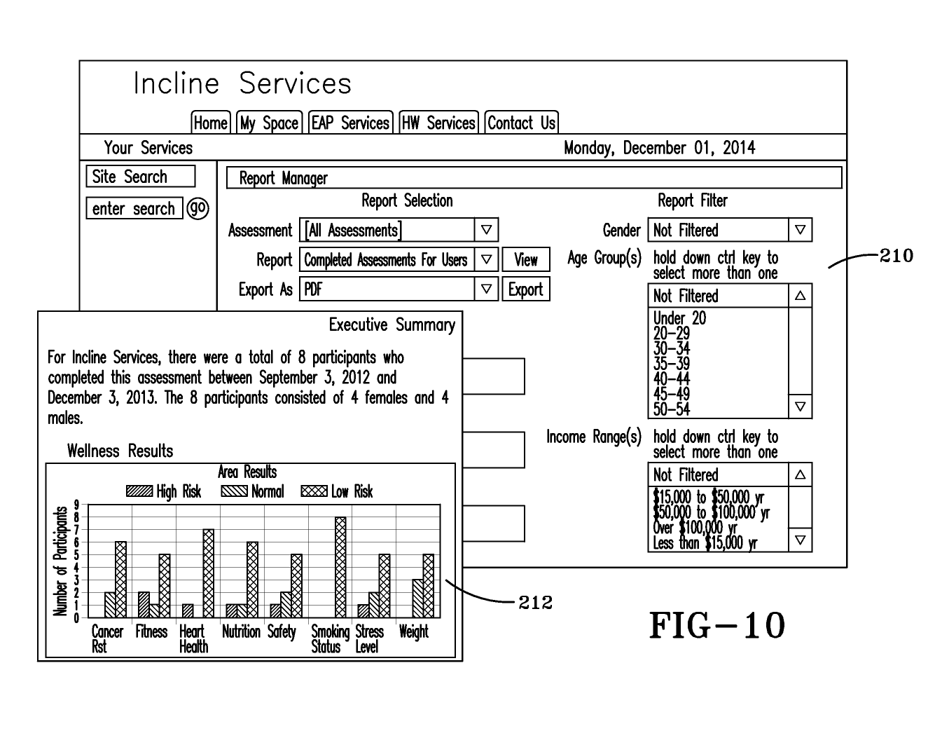

Referring to FIG. 10, sample report manager page elements according to an example embodiment are shown. The report manager provides usage and assessment report features 210. Results may be filtered by client or client group to include special populations or other fields such as gender, age, or income 212. Alternatively, results may be aggregated for an entire population.

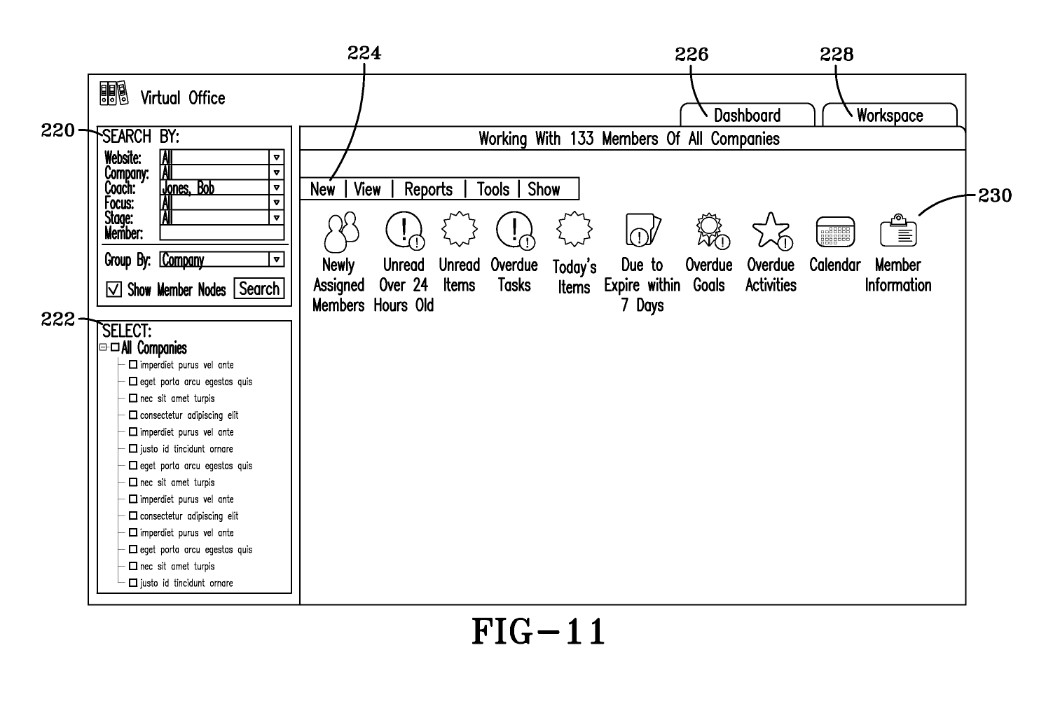

Referring to FIG. 11, a sample coach “virtual office” page according to an example embodiment is shown. The page comprises a “search by” box 220 to search for a specific member or to organize members by “website,” “company,” “focus,” and “stage.” A “website” option lists the websites within which an individual coach works. A “company” option lists the companies or contracts (co-brands) with which an individual coach works. The “coach” field defaults to the individual coach accessing the portal. A “focus” option lists the supported coaching areas and displays the names of members that have opted to work within that specific area of focus. In an example embodiment, the focus areas may comprise: blood pressure; cholesterol; healthy eating; increase energy; physical activity; smoking cessation; and stress management. The “stage” option lists the different coaching process stages in which members are working. In an example embodiment, the stages may comprise: welcome/follow up; tracker review; intake follow up; goal setting; assessment review; and activity setting. The “member” option allows a coach to search for a specific member by typing a portion of or a member's entire name. The “group by” option allows a coach to organize selections by any single search feature identified above.

The “select” box 222 lists a coach's members. Members are listed by company if no search parameters have been selected. If search parameters are selected, only those members that match the selection criteria are listed.

A taskbar near the top of the page 224 allows the coach to access various areas of the portal such as “new (to initiate new interactions or documentation),” “view (view member actions and documentation),” “reports (access reports module),” “tools (access tools for managing preferences),” and “show.” The page may further comprise a set of icons 230 providing “shortcut” access to the most relevant information. In an example embodiment, the shortcuts include: “newly assigned members;” “unread over 24 hours old;” “unread items;” “overdue tasks;” “today's items;” “due to expire in 7 days;” “overdue goals;” “over activities;” “calendar;” and “member information.”

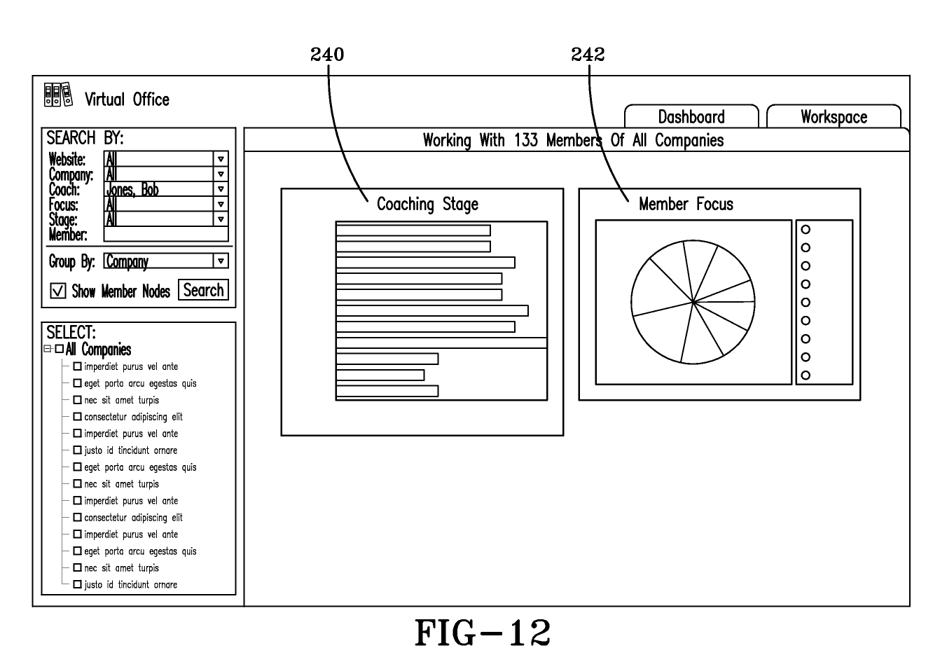

The “dashboard” tab 226 allows a coach to see where members or a subset of members are within the coaching process and the breakdown of their chosen areas of focus. Referring to FIG. 12, a sample “dashboard” page according to an example embodiment is shown. In an example embodiment, the coaching stage dashboard graph 240 displays all stages of the coaching process and the number of selected members currently working within each stage. The member focus graph 242 displays the coach's coaching areas of focus and the number of selected members working within each of these areas.

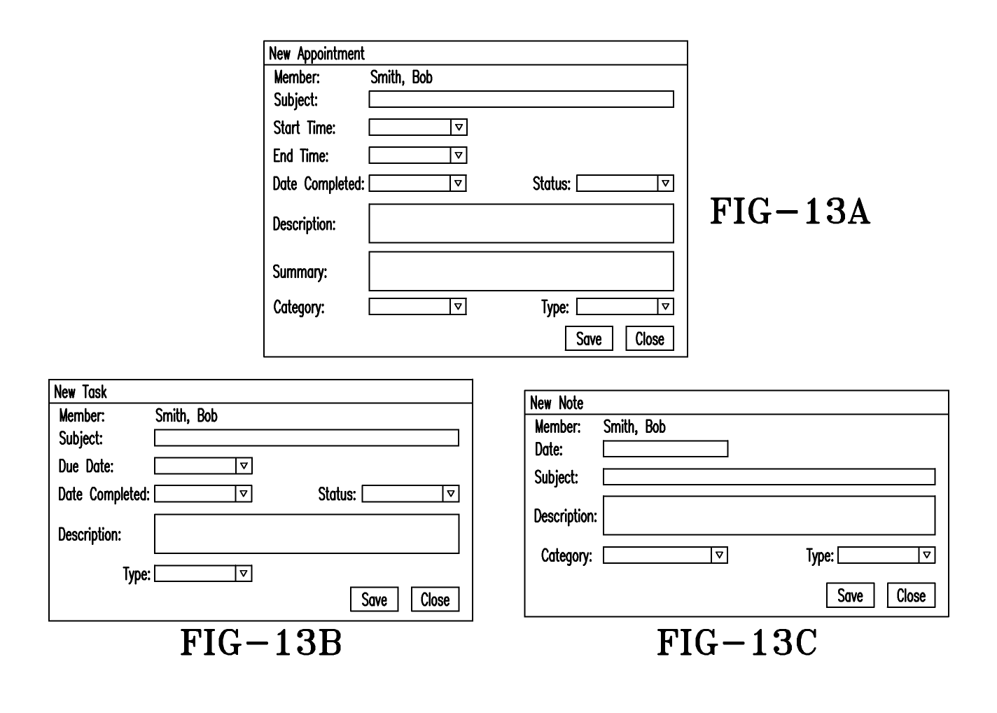

Referring again to FIG. 11, the “workspace” tab 228 of FIG. 11 provides the gateway to coach and member interactions and documentation. The “new” option allows a coach to initiate interactions or documentation. New interactions may include new appointments, tasks, or notes. Referring to FIG. 13A, a sample “appointment” dialogue box is shown. A coach may schedule an online, telephonic, or in-person appointment with a member by completing the subject line, entering other pertinent information, and then selecting save and close options. Referring to FIG. 13B, a sample “task” dialogue box is shown. A coach may create a task as a reminder to take an action by completing the subject line, entering pertinent information, then selecting save and close options.

Referring to FIG. 13C, a sample “note” dialogue box is shown. A coach may create a note for a member with initial survey information or other information the coach would like to add by completing the subject line, entering pertinent information, then selecting save and close options. Any coach action taken generates an automatic coach note for that member. A “goal” feature similar to the notes feature allows a coach to create goals for each member. The coach selects a category and a template from a drop down menu. A date range automatically defaults to one month but can be changed.

An “add new resources” feature, similar to the other “new” features, allows a coach to send resources and surveys to members. Resources such as surveys may be selected from a dialogue box. An email notification may then be sent to the member informing the member of the availability of the survey.

A message feature allows a coach to send emails to multiple or single members. A template option allows the coach to select an email template from the drop drown menu. Other typical email features such as subject, message, signature, and save/send/close are supported.

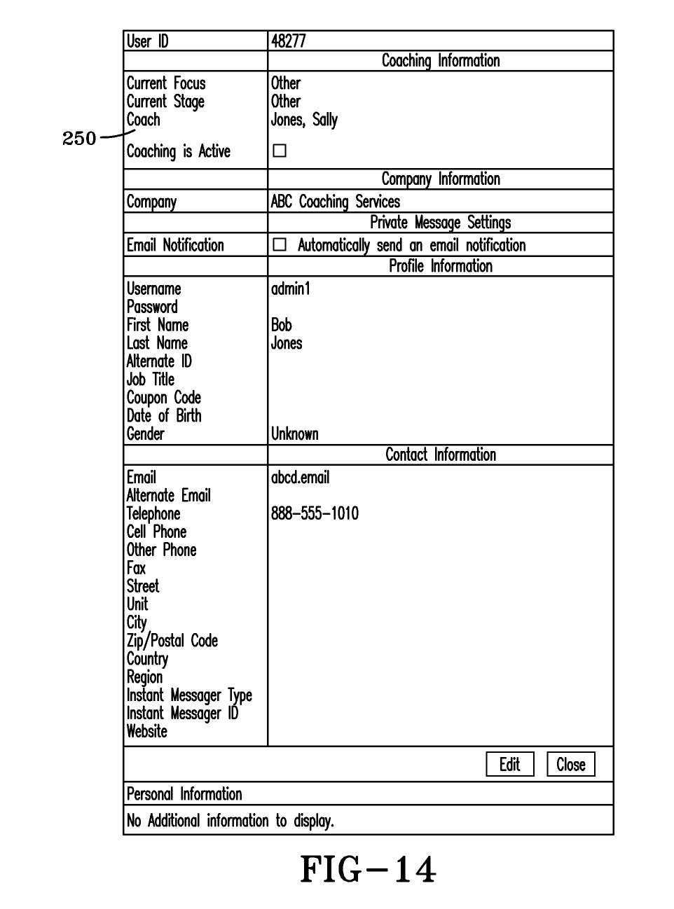

Referring to FIG. 14, a sample “add new member” dialogue box according to an example embodiment is shown. This dialogue box supports the entry of member data. The member information typically comprises identifying and contact information. When adding the member, the coach can include coaching details 250 such as a current focus and a current coaching stage for the member as well as an indicator as to whether coaching is active for the member.

A view option from the workspace page of FIG. 11 allows a coach to view coach and member actions and documentation. Data tables are generated by selecting one of the options (calendar; appointments; tasks; coach notes; goals; activities; progress notes; private messages; completed assessments/surveys; assigned resources; protocols and resources; member files; and member information) from a member. Each generated table may be sorted.

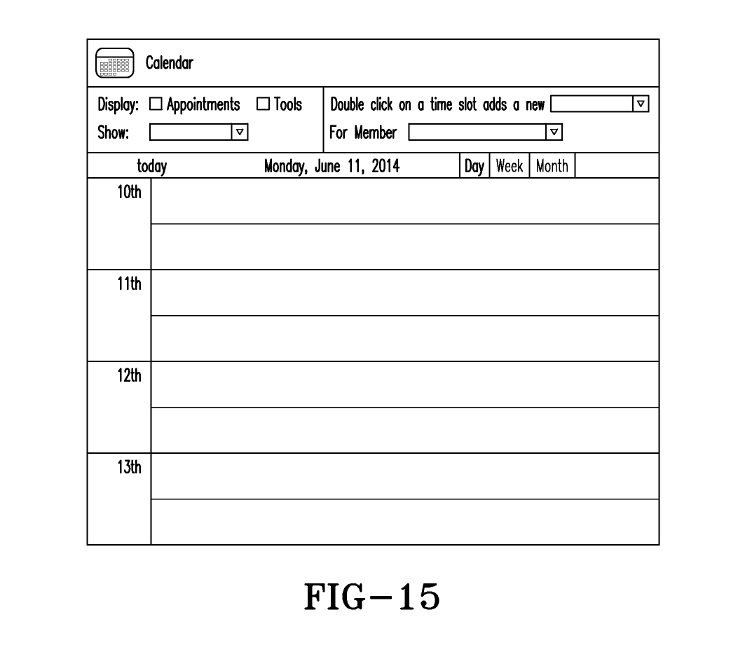

Referring to FIG. 15, a sample “calendar” dialogue box according to an example embodiment is shown. A coach may view appointments and tasks and select from the options of appointments, tasks, show, add a new, for member, day, week, month, and timeline.

Referring to FIG. 16A, a sample “appointments” dialogue box according to an example embodiment is shown. A coach may view scheduled appointments, check for the current day's appointments, and sort them by the designated columns. Referring to FIG. 16B, a sample appointment details dialogue box is shown.

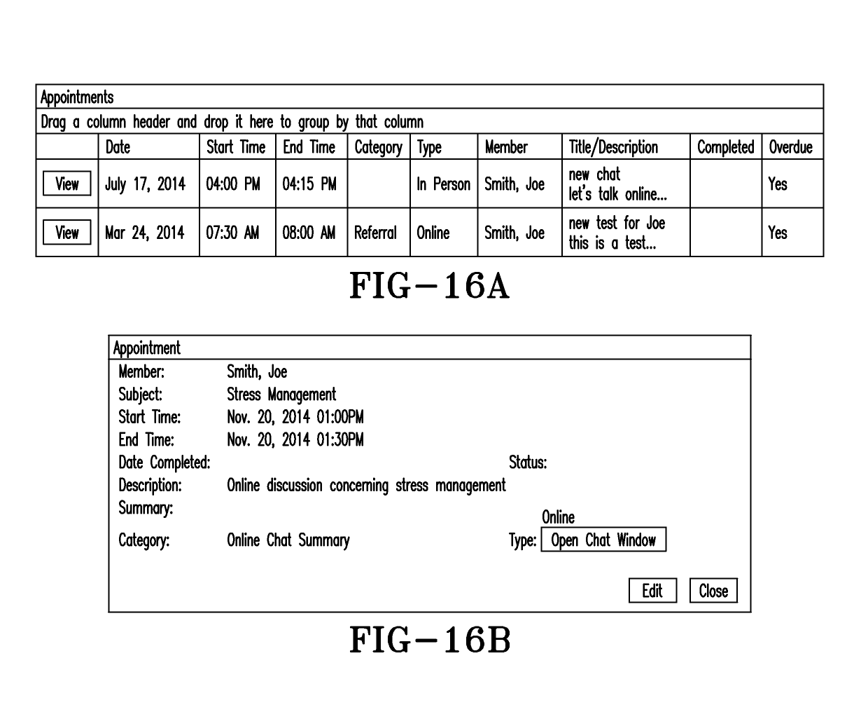

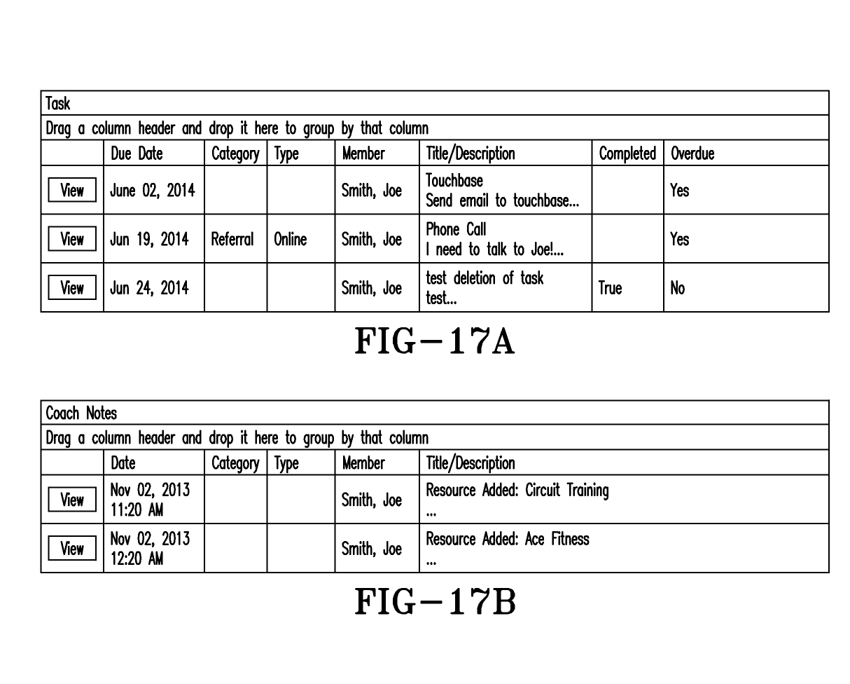

Referring to FIG. 17A, a sample “task” dialogue box according to an example embodiment is shown. A coach may view scheduled tasks, check for the current day's tasks, and sort them by the designated columns. Referring to FIG. 17B, a sample coach's notes dialogue box according to an example embodiment is shown. A coach may view notes, sort them by the designated columns, and select a “view” option to see details.

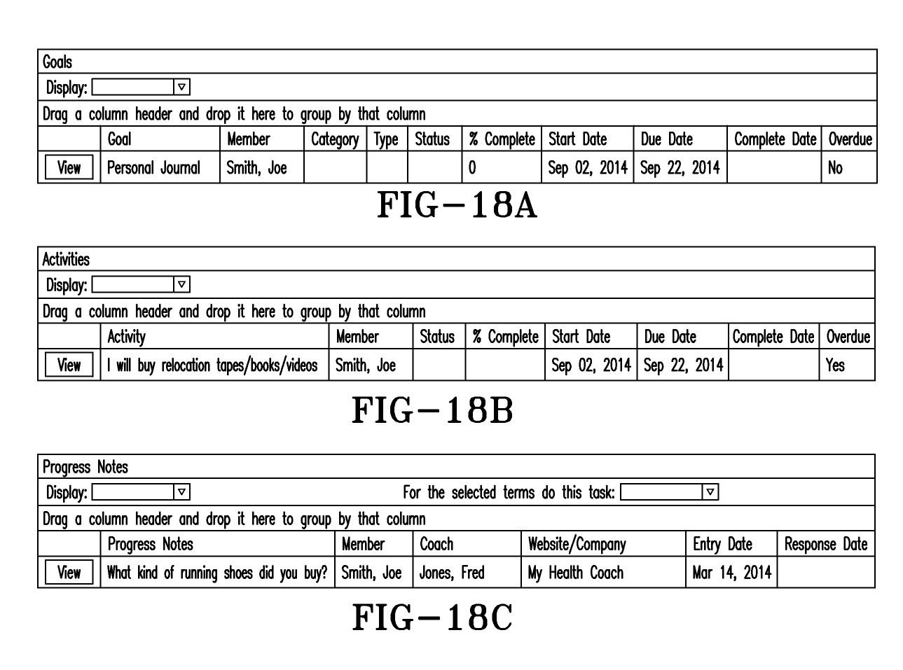

Referring to FIG. 18A, a sample “goals” dialogue box according to an example embodiment is shown. A coach may view a member's goals, sort them by designated columns, and reply to progress notes. The coach may also add a new activity by selecting an “add” option, selecting an activity category, and specifying an activity title. The coach enters an appropriate description of the activity. A date range automatically defaults to two weeks but can be changed.

To view activities related to a goal, a coach may select a “view” option next to the goal. Referring to FIG. 18B, a sample activities dialogue box according to an example embodiment is shown. A coach may view activity details or edit them to change the category, title, date range, completion status and/or any other activity detail. The coach may select an “add a new progress note entry” to add a progress note about this activity. The coach can send an email notification that a progress note has been entered by selecting a “notify member” option. A progress note entries option allows a coach to view a progress note in more detail as shown in FIG. 18C. The coach may send an email notification that a progress note has been entered by selecting a “notify member” option. The coach may also view “overdue items” or “not overdue items” by selection of an appropriate option from the display menu.

Referring to FIG. 19A, a sample “activities” dialogue box according to an example embodiment is shown. This dialogue box allows a coach to view members' activities, sort them by any of the designated columns, and reply to progress notes. To view an activity in more detail, the coach may select a “view” option next to the selected activity. The coach may select an “edit” option to change the category, title, date range, completion status and/or other activity details as shown in FIG. 19B. The coach may select an “add a new progress note” option to add a progress note about the activity as shown in FIG. 19C. To send an email notification that a progress note has been added, the coach may select a “notify member” option.

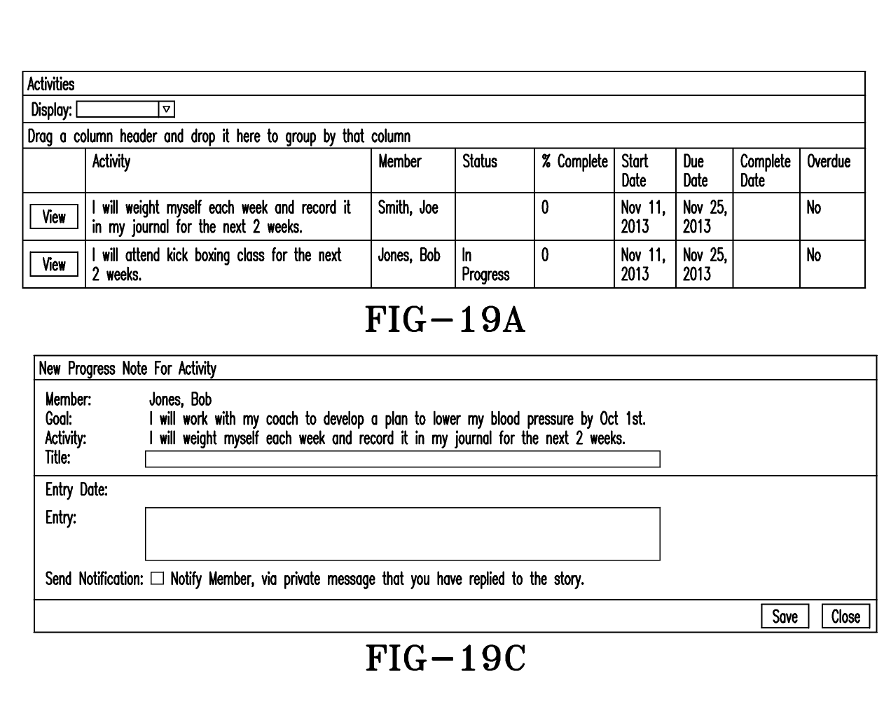

Referring to FIG. 20, a sample “progress notes” dialogue box according to an example embodiment is shown. This dialogue box allows a coach to view members' progress notes, sort them by the designated columns, and reply to progress notes. A “view” option allows the coach to view progress note details that are similar to the details for activities. The coach may also edit or delete the note. To send an email notification that a progress note has been added, the coach selects a “notify member” option.

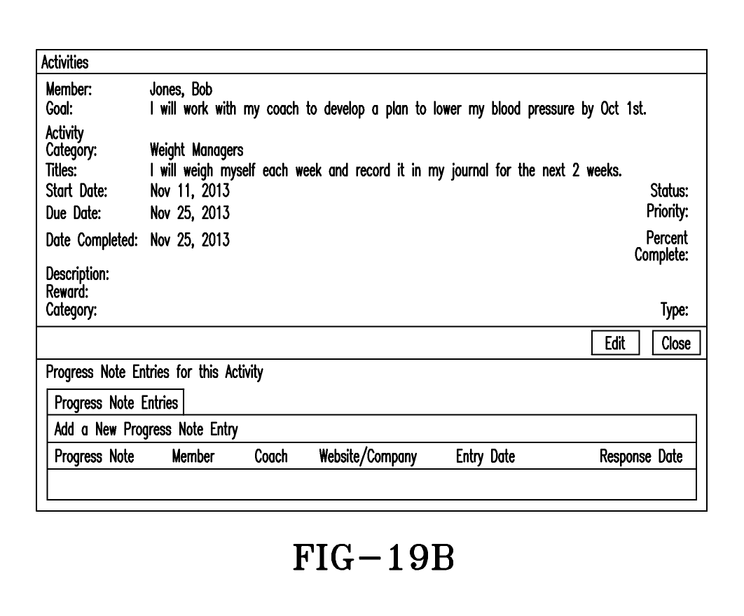

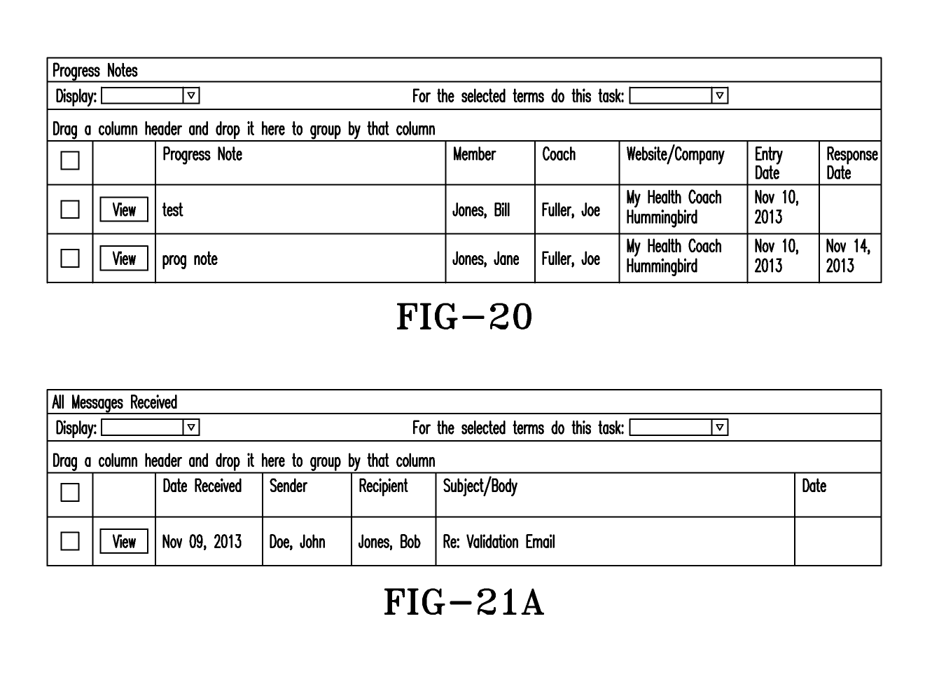

Referring to FIG. 21A, a sample “private messages” dialogue box according to an example embodiment is shown. This dialogue box allows a coach to view messages received, messages sent, messages archived, and draft messages. If a view indicator is highlighted for a sent message, the message has not been read by the recipient. A new messages feature allows a coach to view all messages received and sort them by the designated columns. To view a message in more detail or to reply, the coach may select a “view” option next to the desired message and view a message as shown in FIG. 21B. The coach may select a reply option to navigate to a page for responding to the message as shown in FIG. 21C. Similar features may be provided for sent messages, archived messages, and draft messages.

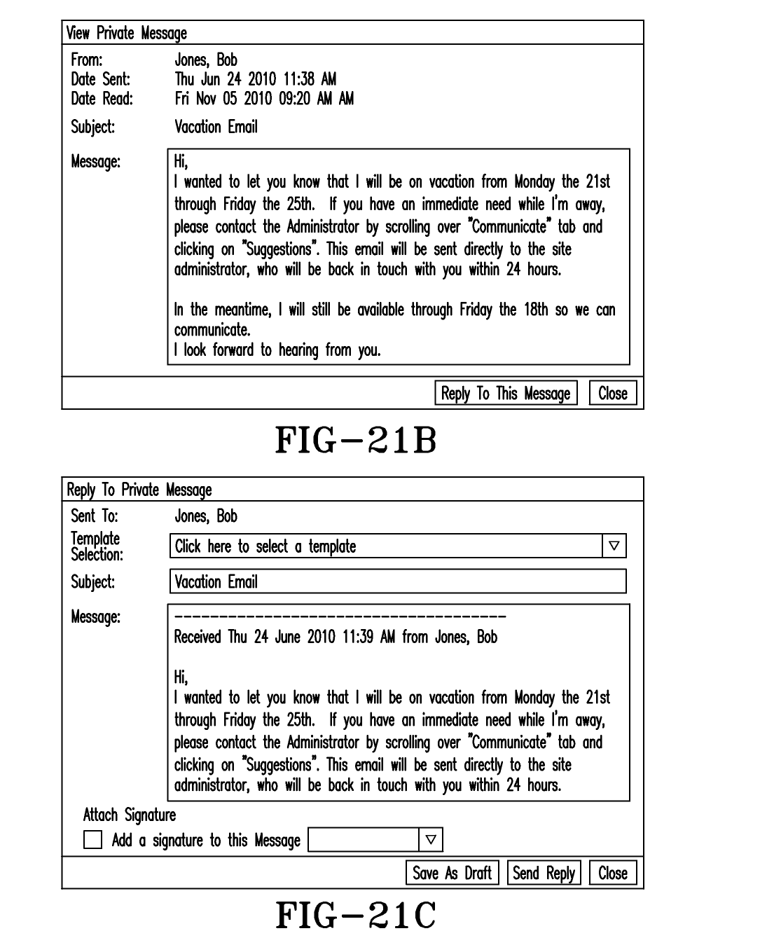

Referring to FIG. 22A, a sample “complete assessments/surveys” dialogue box according to an example embodiment is shown. This dialogue box allows coaches to view assessments and surveys completed by members and sort them by the designated columns. If a view option is highlighted for a sent message, the message has not been read by the recipient. To view a survey or assessment in more detail, the coach may select a view option next to the desired survey or assessment. The “continue” option allows the coach to review the entire survey or assessment. The coach may select from options for marking items as read or unread.

Referring to FIG. 22B, a sample “assigned resources” dialogue box according to an example embodiment is shown. This dialogue box allows coaches to view assigned resources and to sort them by the designated columns. Selection of an item title opens the desired resource. To remove a resource from a member's page, the coach selects the box next to the selected resource or resources and selects a remove selected items option. Referring to FIG. 22C, a sample “protocols and resources” dialogue box according to an example embodiment is shown. This dialogue box allows coaches to view protocols and resources available on the website and sort them by the designated columns. Various options are supported for selecting protocols or resources that apply to the selected member.

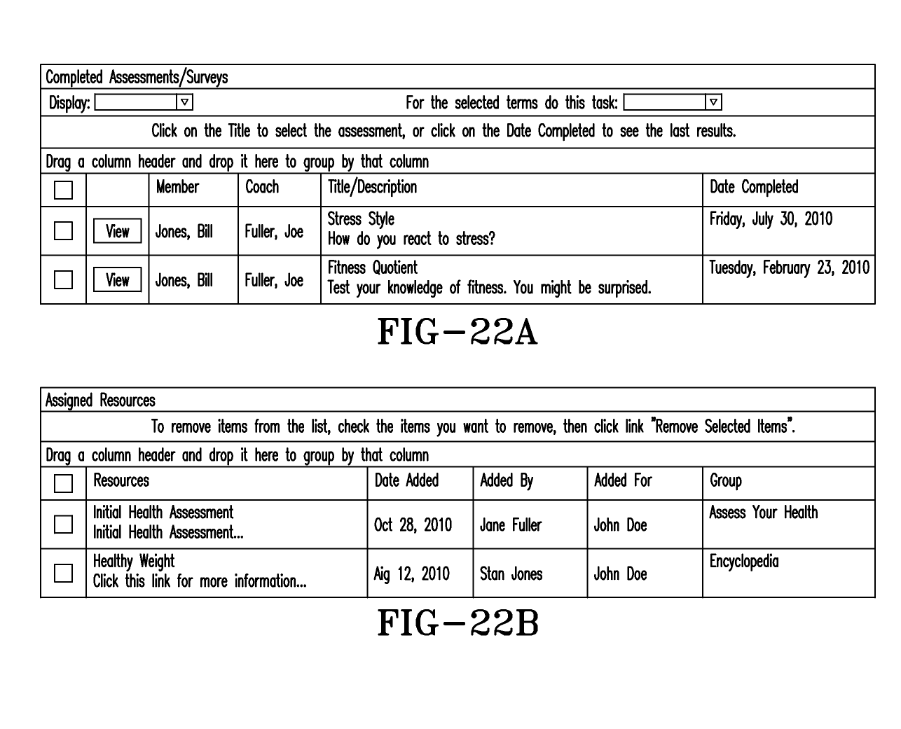

Referring to FIG. 23, a sample “member information” dialogue box according to an example embodiment is shown. This dialogue box allows coaches to view and edit a member's profile as shown in FIG. 14. This feature may be accessed by selecting a person icon next to a member's name wherever it appears. This icon also provides a shortcut for sending members a message and for updating their areas of focus and coaching stages.

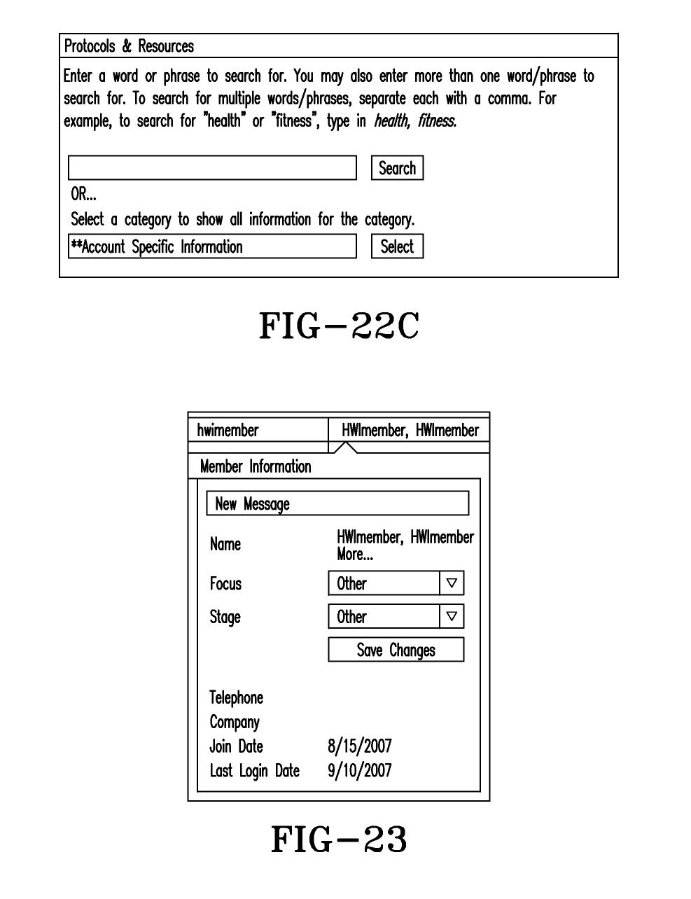

A reports feature allows a coach to generate informational reports summarizing coach-member activity and member listings. Data tables are generated by selecting an option listed in a drop down menu. Each generated table may be sorted by a single column or multiple columns. Referring to FIG. 24A, a sample “member appointment and tasks counts” dialogue box according to an example embodiment is shown. This feature allows coaches to view and sort the number of tasks and appointments assigned to their members and to determine which members are missing a next step (task or appointment) entry. Tasks are next-step actions a coach sets for their work with members (e.g., outreach following sent email). Appointments are scheduled live interactions with members (e.g., online chat, telephonic interaction). Totals are calculated from a coach's scheduled tasks and appointments across all active members.

Referring to FIG. 24B, a sample “member activity report” dialogue box according to an example embodiment is shown. This feature allows coaches to quantitatively view documentation of goals and activities, coach-member interactions, and member activity level. The report may comprise activity details such as the following.

TABLE 2
Member Activity Report Details

| Item | Description |
|---|---|
| # Logins | number of times each member logged into |
| | the site during the specified time period |
| Last Login | date of the last member login during the specified time |
| Date | period |
| Goals Start | number of new goals started during the specified time |
| | period |
| Goals Finish | number of goals completed during the specified time |
| | period |
| Activities Start | number of activities started during the specified |
| | time period |
| Activities | total number of activities completed during the specified |
| Finish | time period |
| Notes Total | total number of progress notes (journal entries) |
| | submitted by the member during the specified time |
| | period |
| Notes Replied | total number of replies from the coach to member- |
| | submitted progress notes |
| Messages | total number of messages (emails) sent from member to |
| Member | coach during the specified time period |
| Messages | total number of messages (emails) sent from coach to |
| Coach | member during the specified time period |
| Appointments | total number of appointments (online, in-person and |
| Total | telephonic) during the specified time period |
| Appointments | total number of phone appointments (telephonic |
| Phone | interactions) that occurred during the specified time |
| | period. |

Referring to FIG. 24C, a sample “current members” dialogue box according to an example embodiment is shown. This feature allows a coach to view and sort a list of current members. In an example embodiment, the list comprises each member's join date, last login date, last coach note, and number of unread messages and progress notes. A related feature allows a coach to view and sort a list of inactive members. In an example embodiment, the list comprises each member's join date, last login date, last coach note, and number of unread messages and progress notes at the time of deactivation.

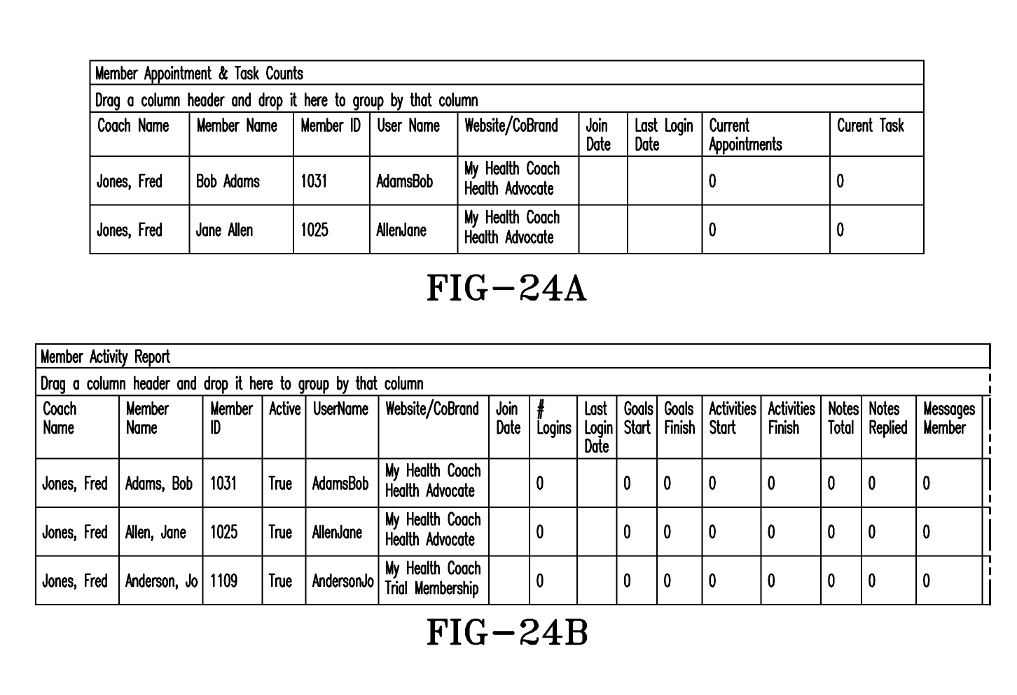

The “unread over 24 hours old” icon of FIG. 11 allows a coach to view unread messages, progress notes, and completed assessments/surveys sent 24 hours or more prior to the current time. Referring to FIG. 25A, a sample “unread messages” dialogue box according to an example embodiment is shown. This dialogue box allows a coach to view messages received 24 hours or more prior to the current time and to sort them by the designated columns. A coach may view a message as shown in FIG. 25B and reply to a message as shown in FIG. 25C. Items may be marked as read, marked as read and moved to an archive, or marked as unread. Similar functionality is provided for unread progress notes as illustrated in FIG. 26A and unread completed assessments and surveys as illustrated in FIG. 26B.

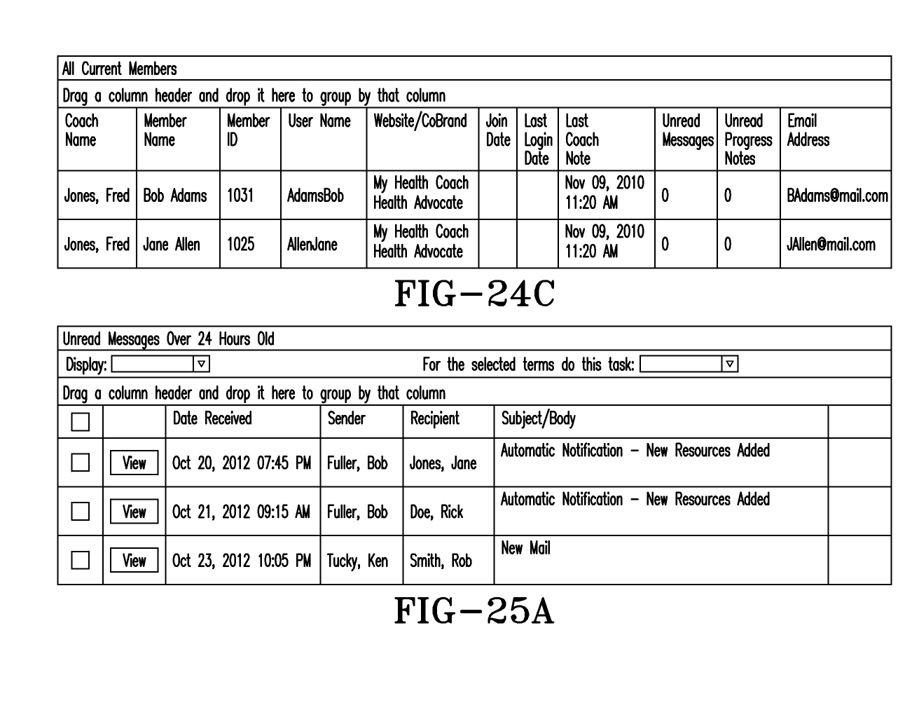

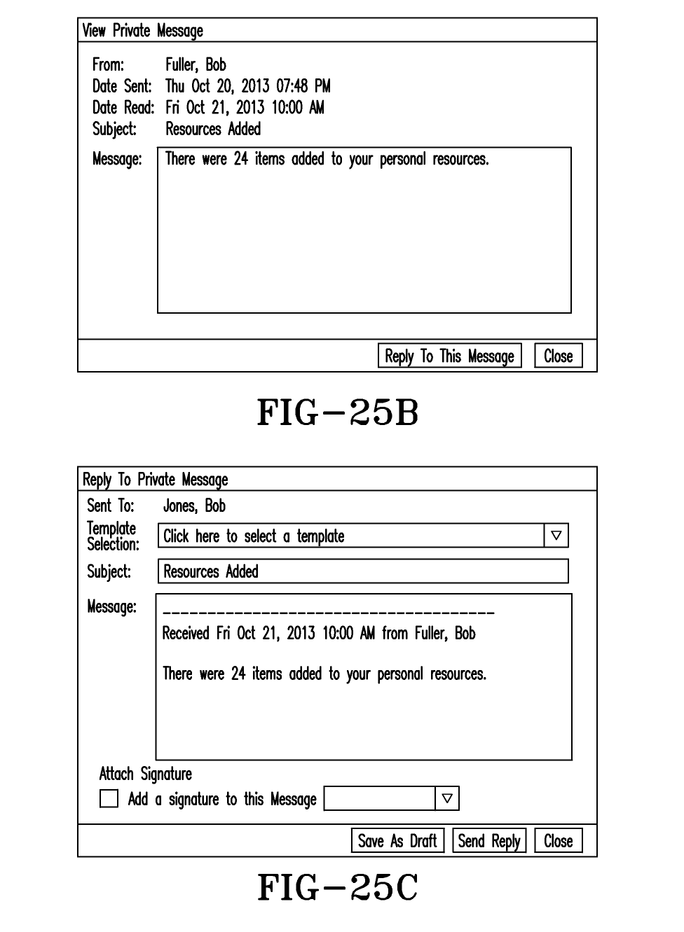

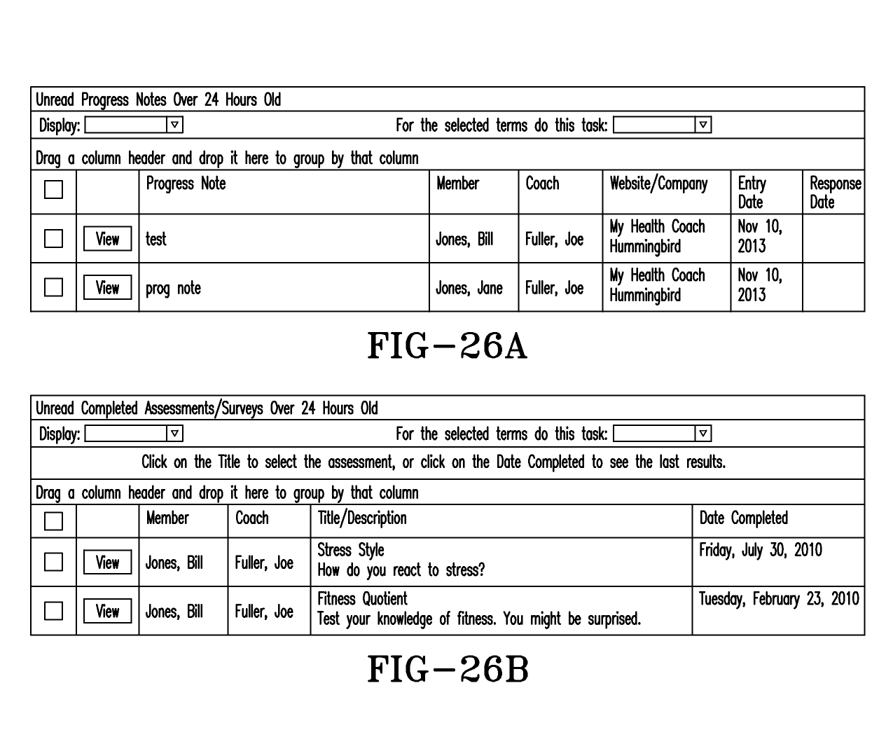

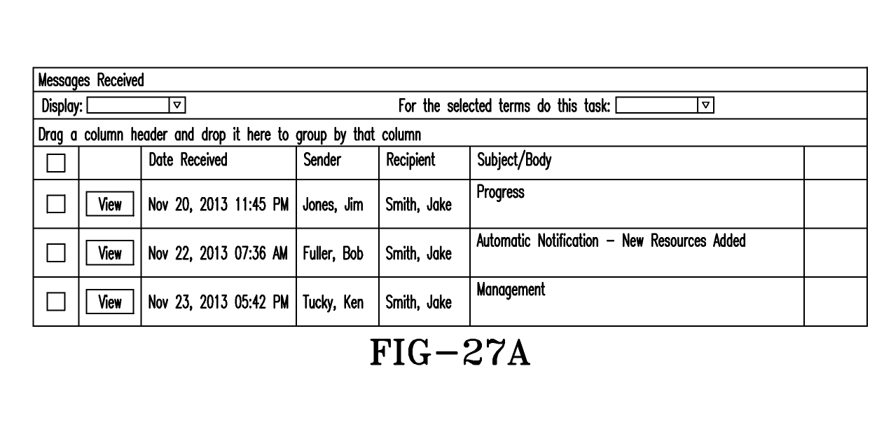

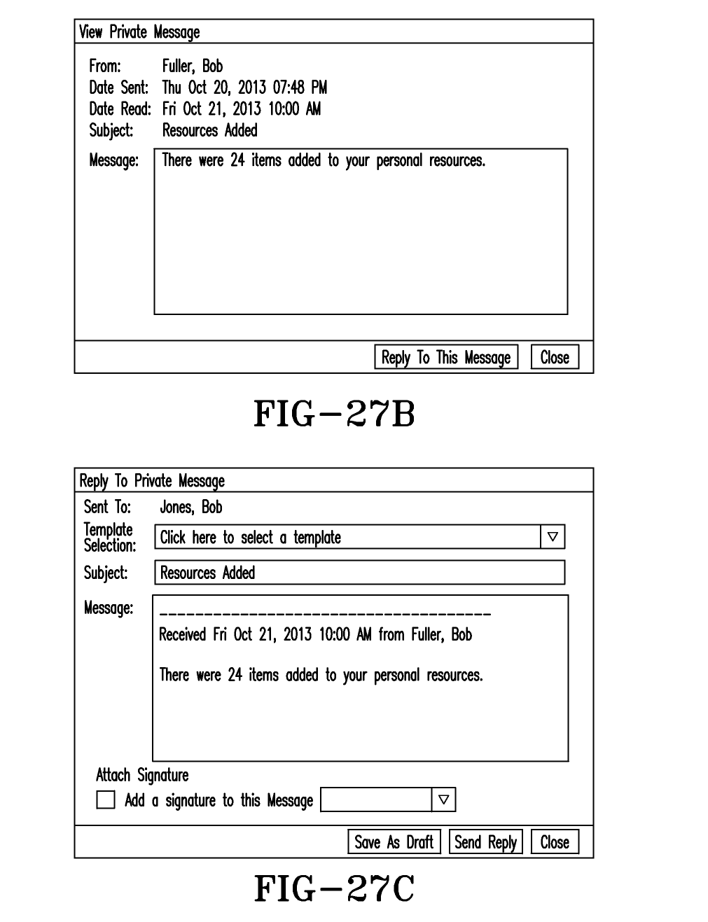

An “unread items” icon accessible from the workspace page of FIG. 11 allows a coach to access unread items such as messages, progress notes, and uncompleted assessments/surveys. FIGS. 27A-27C and FIGS. 28A-28B illustrate features similar to those for items more than 24 hours old but for accessing unread items that are less than 24 hours old.

An “overdue tasks” icon accessible from the workspace page of FIG. 11 allows a coach to access details for overdue tasks. Referring to FIG. 29, a sample “overdue tasks” dialogue box according to an example embodiment is shown. This feature allows a coach to view overdue tasks established to help organize work with members. Task details may be viewed by selecting a “view” option next to a task. The task details may then be edited.

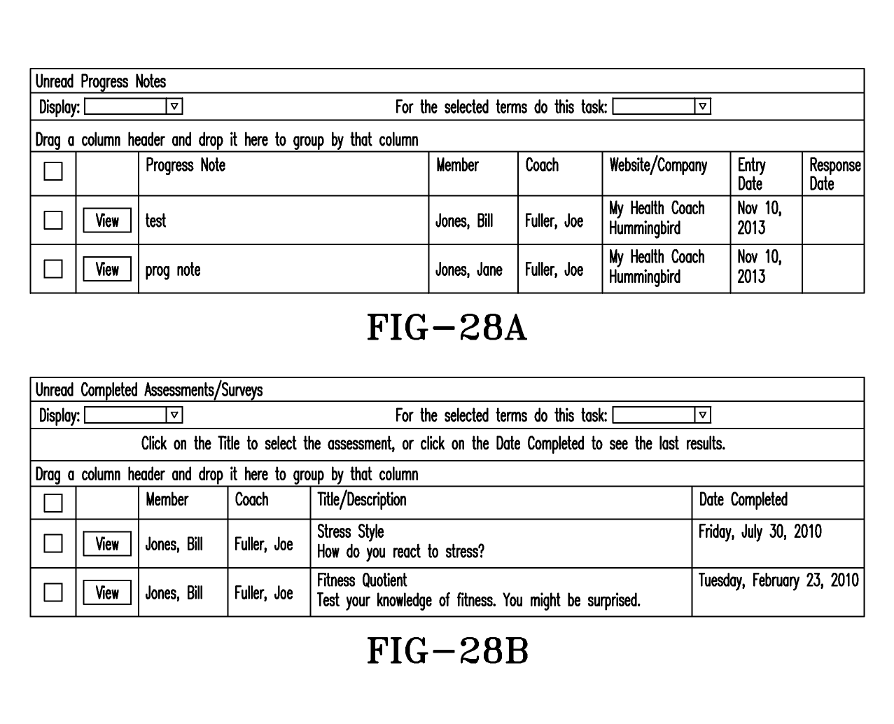

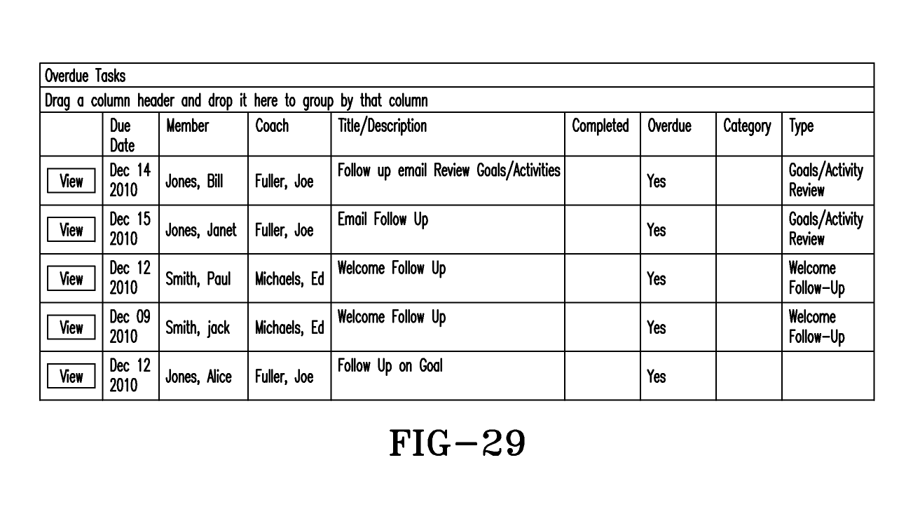

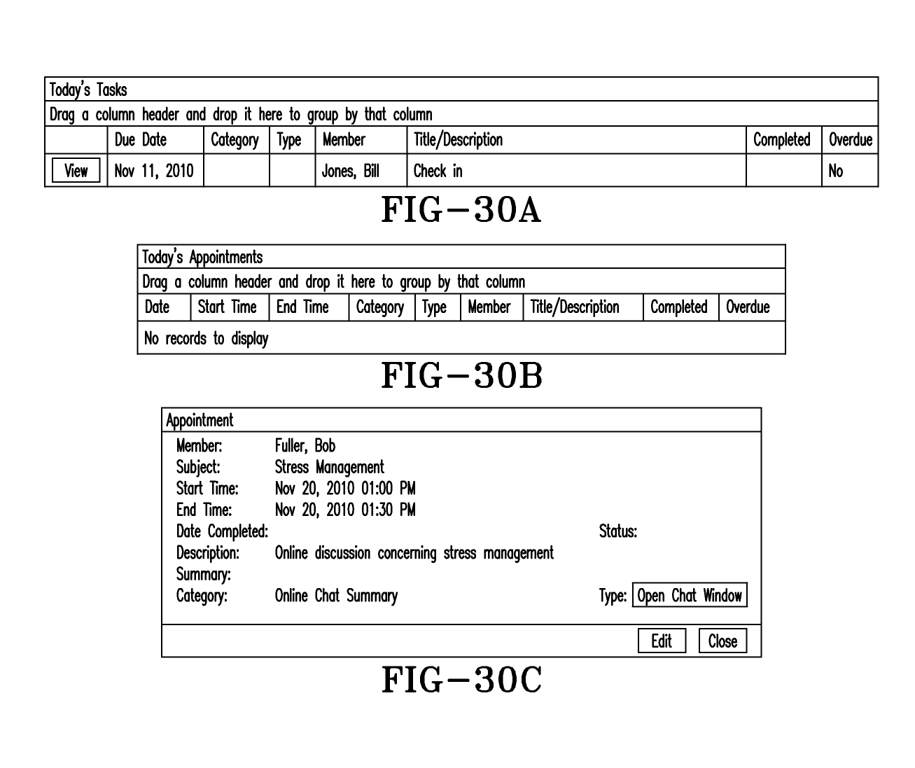

A “today's items” icon accessible from the workspace page of FIG. 11 allows a coach to view tasks and appointments scheduled for the current day. Referring to FIG. 30A, a sample “today's tasks” dialogue box according to an example embodiment is shown. This feature allows a coach to view the tasks scheduled for the current day and to sort them by the designated columns. Task details may be viewed by selecting a “view” option next to a task. The task details may then be edited. Referring to FIGS. 30B and 30C, similar viewing and editing features are provided to “today's appointments.”

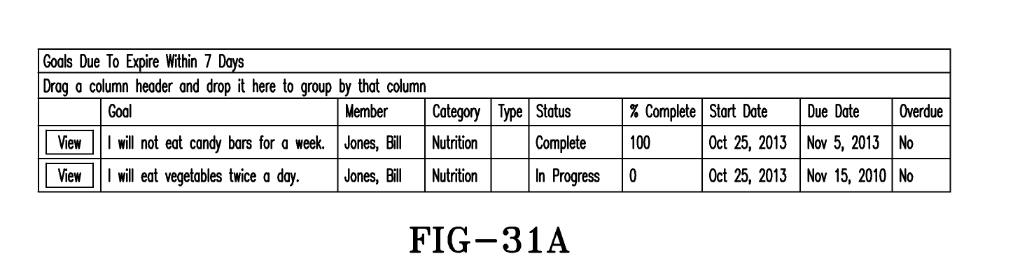

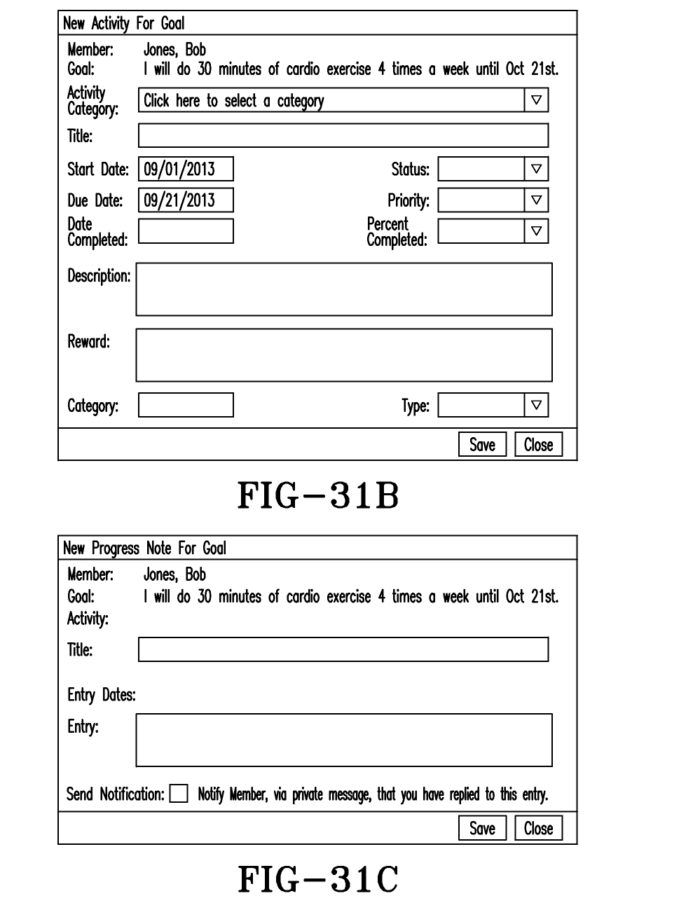

A “due to expire within 7 days” icon accessible from the workspace page of FIG. 11 allows a coach to view items that will expire within a week. This feature allows a coach to view goals and activities due to be completed within the next seven days from the current date. Referring to FIGS. 31A-31C, sample dialogue boxes for a “goals due to expire” feature according to an example embodiment are shown. The coach may view the goals from the dialogue box of FIG. 31A. A new activity for the goal may be defined in the dialogue box of FIG. 31B and a new progress note for the goal may be defined in the dialogue box of FIG. 31C. Similar functionality is provided for activities due to expire within seven days.

“Overdue goals” and “overdue activities” icons are also accessible from the workspace page of FIG. 11. These icons allow a coach to access dialogue boxes similar to the dialogue boxes for “due to expire items.” The goals and activities that are listed are overdue in relation to the current date.

The computerized platform described herein allows a coach to manage coaching services for numerous individuals that have different needs and that are at different stages in the coaching process. The platform facilitates tracking of health goals and related activities and capturing of details related to progress toward goals. The platform further facilitates communications and interactions with members so that each member is provided with personalized attention and advice that increases the likelihood he or she will reach a new health goal and establish new health habits. While certain embodiments of the present invention are described in detail above, the scope of the invention is not to be considered limited by such disclosure, and modifications are possible without departing from the spirit of the invention as evidenced by the claims:

1. A computerized method for providing health coaching services to a plurality of members comprising:
(a) identifying at a computer a plurality of health focuses;
(b) identifying at said computer a plurality of coaching process stages;
(c) storing in a database at said computer for each of a plurality of individuals a member record comprising;
(1) identifying data for said member;
(2) a company client identifier;
(3) a health focus for said member; and
(4) a coaching process stage for said member;
(d) receiving at said computer said company client identifier;
(e) receiving at said computer a request to generate for said company client identifier a display comprising member health focus and coaching process stage data for a plurality of members with said company client identifier;
(f) in response to receiving said request, calculating at said computer for each health focus a number of members associated with said health focus;
(g) in response to receiving said request, calculating at said computer for each coaching process stage a number of members associated with said coaching process stage;
(h) generating at said computer and transmitting for display at a user computer a screen comprising:
(1) said number of members associated with said health focus; and
(2) said number of members associated with said coaching process stage.

2. The computerized method of claim 1 wherein said health focuses are selected from the group consisting of:
blood pressure, cholesterol, healthy eating, increase energy, physical activity, smoking cessation, and stress management.

3. The computerized method of claim 1 wherein said coaching process stages are selected from the group consisting of:
welcome/follow up, tracker review, intake follow up, goal setting, assessment review, and activity setting.

4. A computerized method for providing health coaching services to a plurality of individuals comprising:
(a) storing in a database at a computer for each of a plurality of individuals a member record comprising;
(1) identifying data for said member;
(2) at least one health goal for said member;
(3) a plurality of activities associated with said health goal for said member; and
(4) for each of said plurality of activities, a due date for said activity;
(b) receiving at said computer a request to generate a display comprising a list, said list comprising at least one activity for each of a plurality of members, wherein:
(1) each item on said list identifies a member, an activity, and a due date; and
(2) said items on said list are sorted by due date; and
(c) generating and transmitting said display to a user computer.

5. The computerized method of claim 4 further comprising:
(d) receiving at said computer a user selection of an item on said list; and
(e) in response to said user selection, generating an activity display comprising:
(1) member data for said member identified on said item;
(2) a description of said activity; and
(3) a goal associated with said activity.

6. The computerized method of claim 4 wherein said due date for said items on said list is a date prior to the current date.

7. The computerized method of claim 6 further comprising:
(d) receiving at said computer a request to compose a message to said member related to said activity;
(e) receiving at said computer content for said message; and
(f) transmitting said message to said member.

8. The computerized method of claim 5 further comprising receiving at said computer a user request to enter a progress note for said activity.

9. A computerized method for providing health coaching services to a plurality of individuals comprising:
(a) storing in a database at a computer for each of a plurality of individuals a member record comprising;
(1) identifying data for a member;
(2) a company client identifier;
(3) at least one health goal for said member; and
(4) for each health goal, a due date for said health goal;
(b) receiving at said computer a request to generate a display comprising a list, said list comprising at least one health goal for each of a plurality of members with different company client identifiers, wherein:
(1) each item on said list identifies a member, a health goal, and a due date; and
(2) said items on said list are sorted by due date; and
(c) generating and transmitting said display to a user computer.

10. The computerized method of claim 9 further comprising:
(d) receiving at said computer a user selection of an item on said list; and
(e) in response to said user selection, generating a health goal display comprising:
(1) member data for said member identified on said item; and
(2) a description of said health goal.

11. The computerized method of claim 9 wherein said due date for said items on said list is a date prior to the current date.

12. The computerized method of claim 10 further comprising:
(d) receiving at said computer a request to compose a message to said member related to said health goal;
(e) receiving at said computer content for said message; and
(f) transmitting said message to said member.

13. The computerized method of claim 10 further comprising receiving at said computer a user request to enter a progress note for said health goal.

14. A computerized method for providing health coaching services to a plurality of individuals comprising:
(a) identifying at said computer a plurality of coaching process stages;
(b) storing in a database at said computer for each of a plurality of individuals a member record comprising;
(1) identifying data for said member;
(2) a health goal for said member; and
(3) a coaching process stage for said member;
(c) receiving at said computer task data for a plurality of tasks, said task data comprising for each task:
(1) identifying data for a member;
(2) a description of said task to be completed by said member;
(3) a due date for said member to complete said task; and
(4) a coaching process stage for said member;
(d) generating at said computer for display at a user computer a screen comprising a list of tasks wherein each item on said list comprises:
(1) identifying data for a member;
(2) a description of said task to be completed by said member;
(3) a due date for said member to complete said task; and
(4) a coaching process stage for said member.

15. The computerized method of claim 14 wherein said coaching process stages are selected from the group consisting of:
welcome/follow up, tracker review, intake follow up, goal setting, assessment review, and activity setting.
